(19) United States
(12) Patent Application Publication
(10) Pub. No.: US 2015/0253236 A1
(43) Pub. Date: Sep. 10, 2015

(54) SYSTEM AND METHOD FOR DETECTION AND SYSTEM AND METHOD FOR WATER TREATMENT

(71) Applicant: ECOLAB USA INC., St. Paul, MN (US)

(72) Inventors: Liang Cheng, Shanghai (CN); Rodney H. Banks, Loda, IL (US); Guo Chen, Shanghai (CN); Heng Li, Shanghai (CN); Chunbo Yu, Shanghai (CN); Jian Xu, Shanghai (CN); Pu Chen, Shanghai (CN)

(73) Assignee: Ecolab USA, Inc., St. Paul, MN (US)

(21) Appl. No.: 14/431,046

(22) PCT Filed: Sep. 24, 2013
(86) PCT No.: PCT/US13/61358

§ 371 Date: Mar. 25, 2015

(30) Foreign Application Priority Data
Sep. 29, 2012 (CN) 2012103769045

(51) Int. Cl. G01N 15/14; C02F 1/52; G01N 15/04

(52) U.S. Cl. CPC G01N 15/1434; G01N 15/04; C02F 1/5209; C02F 1/5281; C02F 2209/105

(57) ABSTRACT

The present invention relates to a detection system and method and a water treatment system and method. The detection system according to the present invention is capable of detecting particle state in a medium. Said detection system comprises: an optical probe comprising of at least one transmitting optical fiber for transmitting light to the medium, and at least two receiving optical fibers for receiving light reflected or backscattered from the medium, with at least the end of the optical probe being positioned in the medium when detection is carried out by the detection system; and a signal processing module connected to the optical probe, for converting optical signals from the receiving optical fibers of the optical probe into electrical signals and determining particle state in the medium on the basis of the electrical signals.

### FIELD OF THE INVENTION

The present invention relates to a detection system and method for water treatment, and more particularly to a detection system and method that enable on-line detection of particles contained in a medium. The present invention also relates to a water treatment system and method, and more particularly to a system and method that enables on-line detection of particle state contained in water and treatment of the water on the basis of the detection results.

### BACKGROUND OF THE INVENTION

Primary wastewater treatment aims to remove or reduce suspended solids and other possible contaminants in raw water or wastewater by deposition or flocculation and chemical treatment. In many industrial sedimentation tanks (clarifier tanks), chemical agents (coagulants and flocculants) are added to promote the coagulation of colloids, thereby accelerating the deposition process of solids. The selection and dosages of the coagulants and flocculants are of importance in the sedimentation tank process. A common problem in primary wastewater treatment is that water quality and quantity vary continuously and thus the dosages of the chemical agents need to be adjusted accordingly and timely. At present, a manual jar test is widely used as a standard method in the industry to select the chemical agents and determine the dosages.

However, the manual jar test has many drawbacks: firstly, it cannot rapidly respond to the changes in wastewater quality and quantity, and secondly, it is labor and time consuming, lacking of responsiveness, and needs to be operated by an experienced operator. If the dosages of the chemical agents are not adjusted timely, discharge water quality may not meet the standards, and thus the risk of downstream process failures may increase. Therefore, there is an urgent need in wastewater treatment processes for a reliable on-line detection system, which ensures consistent and effective clarification by monitoring the coagulation and flocculation processes and optimizing the dosages of the chemical agents.

Many technologies have been applied in the wastewater clarification process to detect coagulation efficiency, for example, the streaming current detector (SCD) has been widely used to control the dosages of coagulants in drinking water treatment. However, charge neutralization is not a unique action mechanism for sedimentation of solids in wastewater treatment, other mechanisms such as polymer bridging, hydrophobic reaction, charge path neutralization and the like are also important. Therefore, the use of SCD as a primary sensor for dosage control of the coagulants and flocculants is inappropriate sometimes in wastewater treatment. Furthermore, conductive interference, probe fouling and high maintenance costs also limit its application in wastewater treatment.

With the rapid development of computer science and digital image processing technology, digital microscopic imaging technology has been applied in many fields so that it is possible to analyze the morphology of particles through imaging and analysis software. Digital microscopic image processing technology enables rapid measurement of the sizes of a large number of floccules and in-situ measurement of floccules in suspensions. Digital microscopic image processing technology achieves the measurement by capturing images on a focusing plane which is a short distance (0.3-1 cm) within the detection container. Image processing is usually necessary to improve image quality for accurate analysis. The key to this technology is to define an appropriate contrast ratio between the object and the background, such that the particle size can be accurately measured.

The use of sedimentation to determine the deposition rate of floccules is important because the deposition rate directly affects the performance of sedimentation tanks and is an important parameter for optimizing the treatment procedure. Deposition is dependent upon size, effective density and porosity of floccules. However, measuring floccule sedimentation requires complex preparation and numerous samples in order to get accurate results.

Particle counting is another important technology, which measures the number of particles within a size range based on optical or electronic detection, providing the information on particle state during the flocculation. Main drawback of this technology is the break-up of floccules when they pass through the measurement cell. In this case, the instrument of this kind, e.g. a Coulter counter, greatly underestimates the floccule size when compared to the optical image analysis technology since it only measures the volume of the solid in the floccule instead of the effective volume of the floccules including voids and water. In addition, the number of particles, the position, and the overlapping of particles in the detection area and other factors significantly affect the accuracy of detection. Due to these reasons, the particle counting technology requires that the measured wastewater has a relatively low particle concentration, which limits its application in water treatment, especially wastewater treatment.

Currently, most of commercial particle size detection instruments use light scattering technology. These instruments measure the particle size by recording the intensity of the scattered light in a range of different angles by an array of detectors arranged in a ring. Small particles scatter light at large angles, while large particles scatter light at small angles. However, because very high turbidity of a water sample leads to significant scattering loss, light scattering technology is only applicable to relatively low turbidity water samples. Moreover, this technology requires steady flow rate of water sample during the measurement, which is sometimes impossible for practical applications.

A Photometric Dispersion Analyzer (PDA) is a unique, commercially available instrument used to measure the change in particle coagulation state. It uses a beam of light to illuminate a flowing suspension to measure fluctuations of transmitted light intensity, which is defined as a flocculation index. The PDA evaluates the effectiveness of the chemical agent on the basis of this index. The measurement principle and method of this technology are disclosed by John Gregory et al. in GB 2182432A. It utilizes a transverse narrow beam of light to illuminate a flowing suspension, and the intensity of transmitted light is detected and output by a detection device. The output signal consists of two components, the direct current signal (DC signal) representing equivalently averaged intensity of transmitted light while the alternating current signal (RMS signal) represents random changes of particle number in the sample. PDA has a function of separating the direct current and alternating current signals from the original output signal. However, this technology has some limitations. For example, when passing through the PDA measurement cell, concentration of the suspended solids must be high enough to provide reliable signals. In addition, mixing intensity and equipment calibration may also affect the accuracy. A relatively small sampling tube may introduce huge shear force, which may break up the floccules. Another limitation is that it is not a real-time measurement. Samples need to be introduced into the measurement cell before detection for coagulation and flocculation. Since the floccules may grow up when passing through the sampling tube, this measurement is unable to detect real particle state. Besides the limitations mentioned above, high cost and other problems limit the application of the PDA in the wastewater treatment industry.

Due to various problems such as reliability, maintenance, complexity, response time and cost, etc., many other technologies are not suitable for direct use in wastewater treatment. So far, there is no successful commercial product in wastewater treatment market which can provide effective online measurement of particle state and optimized control of chemical dosages in primary water treatment. Based on this discussion, currently there is an urgent need for a reliable, sensitive and cost effective on-line system to detect particle state in water treatment. An automatic dosage optimization and control system can reduce the treatment cost; increase effectiveness of clarifier tank, improve downstream treatment processes and overall water treatment capability.

### SUMMARY OF THE INVENTION

An object of the present invention is to provide a reliable and inexpensive on-line optical detection system and method, and accordingly a water treatment system and method.

In one aspect, the present invention provides a detection system for detecting particle state in a medium, characterized by comprising: an optical probe, comprising of at least one transmitting optical fiber for transmitting light to the medium, and at least two receiving optical fibers for receiving light reflected or backscattered from the medium, with at least the end of the optical probe being positioned in the medium when detection is carried out by the detection system; and a signal processing module connected to the optical probe, for converting optical signals from the receiving optical fibers of the optical probe into electrical signals and determining particle state in the medium on the basis of those electrical signals.

In the detection system according to the present invention, the optical probe can comprise a plurality of transmitting optical fibers, which are arranged in a manner to surround the receiving optical fibers. Said optical probe can comprise of eleven transmitting optical fibers and two receiving optical fibers, with six transmitting optical fibers being arranged equidistant around each of the receiving optical fibers. Said optical probe can comprise of fifteen transmitting optical fibers and two sets of receiving optical fibers, with each set thereof comprising of two receiving optical fibers arranged in parallel, and ten transmitting optical fibers being arranged around each set of the receiving optical fibers. Said optical probe can comprise a plurality of transmitting optical fibers and at least two receiving optical fibers, with said plurality of transmitting optical fibers being arranged into two rings linked to each other, and the receiving optical fibers being positioned in the centers of the rings, respectively. In the detection system according to the present invention, said optical probe can further comprise a plurality of filling optical fibers.

In the detection system according to the present invention, said optical probe can comprise a protective window at an end thereof. Said protective window can be made of sapphire or common optical glasses, and it may have thereon a reflection reducing film or an anti-reflection coating for a corresponding medium.

In the detection system according to the present invention, the optical probe can comprise an optical fiber probe and an adaptor, with the transmitting optical fibers and the receiving optical fibers being fixed in the optical fiber probe, and the optical fiber probe and the adaptor being connected by screw threads. Said adaptor can have a hole for fitting the optical fiber probe, with the hole having screw threads on its inner surface and the optical fiber probe having screw threads on its outer surface. The optical fiber probe can comprise a head for facilitating the screwing-in of the optical fiber probe into the hole for fitting the same, with the header comprising of a plurality of anti-skid grooves.

In the detection system according to the present invention, said medium can be a liquid. Particle state can include the change of particle size and the change of particle concentration.

In the detection system according to the present invention, said signal processing module can obtain alternating current signals and direct current signals on the basis of optical signals from the receiving optical fibers, to determine the change of particle size in the medium on the basis of said alternating current signals, and to determine the concentration of the medium on the basis of said direct current signal.

In another aspect, the present invention provides a water treatment system, comprising the detection system as described above for detecting the change of the particle size in water after chemical agents added therein, wherein said water treatment system determines the dosages of the chemical agents required for treating the water on the basis of the detection results from the detection system, and said determined dosages of the chemical agents are added to the water for treating the same.

In the water treatment system according to the present invention, said water treatment system adds the chemical agent or agents into the water a plurality of times, wherein the dosages may be different from time to time; said detection system detects the change of the particle size after each addition of the chemical agent, and said water treatment system determines the dosages of the chemical agents required to treat the water according to the relationship between the dosages of the chemical agents added therein and the change of the particle size.

In a further aspect, the present invention provides a method for detecting particle state in a medium, comprising of transmitting light into the medium via at least one transmitting optical fiber in the medium; receiving light reflected or backscattered from the medium via at least two receiving optical fibers in the medium; and converting optical signals received by receiving optical fibers into electrical signals; and determining particle state in the medium on the basis of the electrical signals.

In the method for detecting particle state in a medium according to the present invention, the light can be transmitted into the medium via a plurality of transmitting optical fibers wherein the transmitting optical fibers can be arranged in a manner to surround the receiving optical fibers. Said medium can be a liquid. Said particle state includes the change of the particle size and the concentration of particles.

In the method for detecting particle state in a medium according to the present invention, the optical signals received by the receiving optical fibers can be converted into alternating current signals and direct current signals, and the change of the particle size in the medium are determined on the basis of the alternating current signals and the concentration of the particles is determined on the basis of the direct current signal. In the method for detecting particle state in a medium according to the present invention, an optical fiber probe comprising of the transmitting optical fiber and the receiving optical fibers can be connected to an adaptor by screw threads.

In a still further aspect, the present invention provides a water treatment method, comprising of adding chemical agents into water; determining and detecting the change of particle size in the water after having added therein the chemical agents; determining the dosages of the chemical agents required for the water treatment according to the detected change of particle state in the water after having added therein the chemical agents; and adding into the water said determined dosages of the chemical agents to treat the water.

In the water treatment method according to the present invention, the chemical agents can be added into the water a plurality of times, wherein the dosage may be different from time to time, and the change of the particle size in the water after the chemical agents are added therein each time is detected, and the dosages of the chemical agents required to treat the water on the basis of this relationship between the dosages of the chemical agents and the change of particle size is determined.

The optical real-time on-line detection probe according to the present invention employs a multiple illumination design and multiple detection channels and receives reflected and backscattered lights from a suspension, and this immersion detection allows the probe to be easily mounted in a pipeline system. The optical real-time on-line detection probe according to the present invention can monitor the conditions of deposition and flocculation in wastewater treatment, thereby achieving real-time control of optimized dosages of chemical agents. In the primary wastewater treatment, specific particle parameters such as concentration, size or size distribution are not necessary to evaluate the deposition and flocculation processes. The multiple illumination design can effectively improve the signal to noise ratio, and the multiple detection channels can substantially improve the detection accuracy of the probe. Although utilizing the similar calculation principle as that of the PDA device, on the basis of reflection and backscattering measurements, the on-line monitoring probe of the present invention successfully solves the break-up problem of floccules during the detection, which is the primary drawback of the PDA device. The probe of the present invention is a compact optical fiber-based reflection probe, which can detect reflected and backscattered optical signals to monitor the state of the coagulation of particles in a flowing or static medium. The optimized arrangement of the optical fibers ensures uniform illumination on a sample and acquisition efficiency of reflected and backscattered optical signals. Flexible configuration of the optical fibers can meet various requirements for sample illustration and optical signal acquisition for various applications, ensuring that the probe can meet various application demands, such as monitoring particle size change in a solution, analysis of gas components, surface detection of a solid substrate on the basis of light scattering, absorption and reflection measurements in the wavelength range from ultra violet (UV) to near-infrared (NIR). Additionally, the probe of the present invention employs a particular circuit system for acquisition, processing and analysis of the multi-channel optical signals. The circuit system can perform a photoelectric conversion on optical signals received by the probe and decompose the original electrical signals into alternating current signals (RMS signal) and direct current signals (DC signal) for subsequent data processing and calibration of the instrument.

According to the present invention, in situ detection of coagulation and/or flocculation of the contaminants are carried out in the primary wastewater treatment, thereby facilitating the control of the optimized dosages of chemical agents.

Advantages and specific embodiments and related preferred embodiments of the present invention will be described in detail with reference to the following accompanying drawings.

### BRIEF DESCRIPTION OF THE DRAWINGS

FIG. 1 is a structural block diagram of a detection system according to the present invention.

FIG. 2 is an exploded view of an embodiment of an optical probe of the detection system according to the present invention.

FIG. 3 is an assembled view of the optical probe shown in FIG. 2.

FIG. 4 is an exploded view of an embodiment of the optical probe of the detection system according to the present invention.

FIG. 5 is a schematic diagram of arrangement of optical fibers in an embodiment of the optional probe according to the present invention.

FIG. 6 is a schematic diagram of arrangement of optical fibers in an embodiment of the optional probe according to the present invention.

FIG. 7 is a schematic diagram of arrangement of optical fibers in an embodiment of the optional probe according to the present invention.

FIG. 8 is a schematic diagram of signal processing according to the present invention.

FIG. 9 is a flow chart of detecting particles in a medium by the detection system according to the present invention.

FIG. 10 is a schematic diagram showing a relationship between the solution turbidity and the direct current signal output of the probe.

FIG. 11 is a schematic diagram showing the RMS signals output and the supernatant turbidity as a function of coagulant dosage.

### DETAILED DESCRIPTION OF THE INVENTION

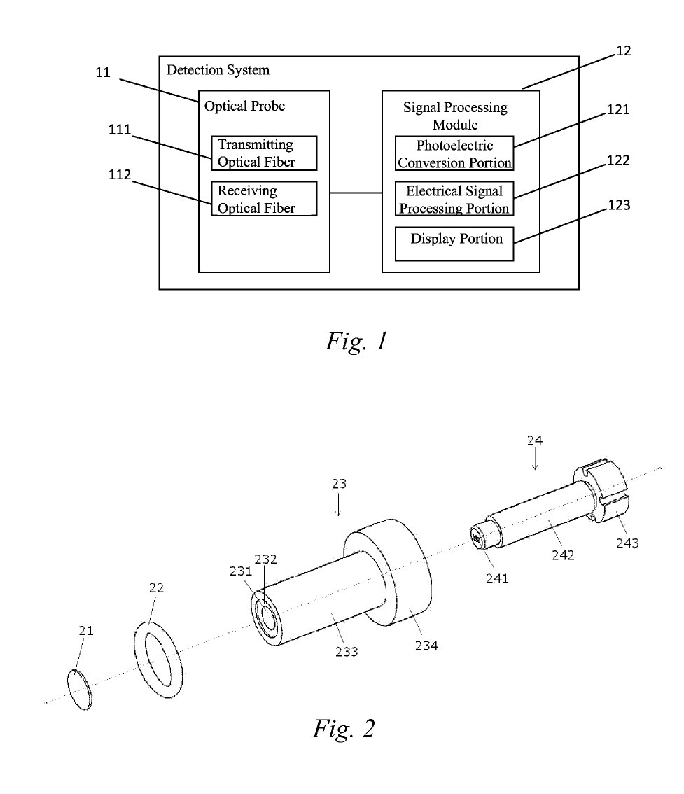

As shown in FIG. 1, the detection system according to the present invention comprises of two portions, i.e. an optical probe 11 and a signal processing module 12. The optical probe 11 comprises of transmitting (illumination) optical fibers 111 and receiving (reading) optical fibers 112. The branch having the illumination optical fibers 111 can be connected to a light source through a mechanical adapter for transmitting the light emitted from the light source to a medium to be detected. The light source can be, for example, an infrared emitting diode (IRED) having a center wavelength of 850 nm. The receiving optical fibers 112 are used for receiving light reflected by the medium and can be connected to optical detectors such as photodiodes through a mechanical adapter. At the detection terminal, the optical probe 111 can be directly used in practical applications, and alternatively connected to a specific mechanical member for a particular mechanical installation. Specific structure of the optical probe 111 will be described in detail hereafter.

The signal processing module 12 comprises a photoelectric conversion portion 121, an electrical signal processing portion 122 and a display portion 123. The photoelectric conversion portion 121 converts optical signals from the receiving optical fibers 112 into electrical signals via optical detectors, which can be, for example, photodiodes. The electrical signal processing portion 122 processes the electrical signal from the photoelectric conversion portion 121 to determine the nature of particles in the medium being detected. The display portion 123 displays the processed results to a user (detector).

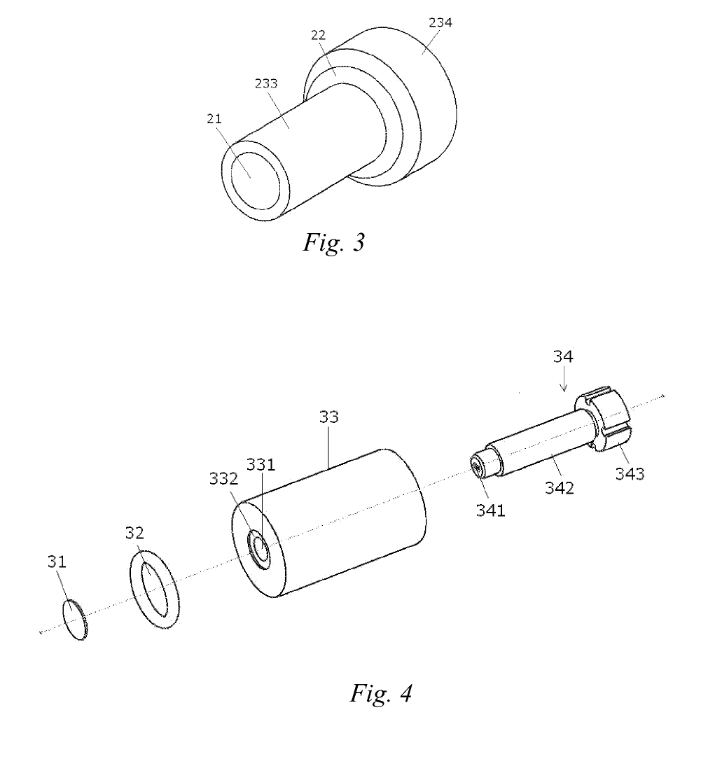

FIGS. 2 and 3 show the structure of an embodiment of the probe of the present invention. FIG. 2 shows an exploded view of the probe. FIG. 3 shows a schematic diagram of FIG. 2, with each of the components being assembled together. In this embodiment, the probe comprises of an adapter 23, an optical fiber probe 24, an O-ring 22, and a protective window 21. The adapter 23 resembles a bolt in shape, and has a larger and a smaller cylinder 233, 234 integrally formed. A hole 231 is at the center of the adapter 23, extending through therein for fitting the optical fiber probe 24. The adapter 23 can be made of stainless steel. It will be understood by a person skilled in the art that the shape, structure and material of the adapter 23 can be selected at will, as long as it can fix the optical fiber probe 24 and has a desired strength and corrosion resistance to a medium to be detected. An optical fiber bundle 241 of the optical fiber probe 24 comprises of at least one transmitting optical fiber and at least two receiving optical fibers. Optionally, the optical fiber bundle 241 also comprises of multiple filling optical fibers and/or other structures for fitting the optical fibers. The optical fiber probe 24 also comprises of a fitting portion 242 for fitting the optical fibers 241. The fitting portion 242 fits in with the fitting hole 231 of the adapter 23, and has a shape and size substantially corresponding to those of the fitting hole 231. In a preferred embodiment, the fitting portion 241 has screw threads on its outer surface and the fitting hole 231 has screw threads on its inner surface, whereby they can be connected through interference fit together by the screw threads. The optical fiber probe 24 also comprises of a header 243 connected to the fitting portion 242 for facilitating the screw-in of the fitting portion 242 of the optical fiber probe 24 into the fitting hole 231 of the adapter 23. Preferably, the header 243 also comprises of a plurality of anti-skid grooves (four grooves shown in the embodiment of FIG. 2) to increase the friction between a hand and the header, thereby further facilitating the screwing-in of the fitting portion 242 of the optical fiber probe 24 into the fitting hole 231 of the adapter 23.

The optical probe (or the optical fiber bundle 241) on the end thereof towards the medium has a protective window 21. The protective window 21 can be mounted into a recess 232 on the end of the adapter 23 that faces the medium by adhesives or other means. Since the probe may operate in various extreme environments, the additional protective window 21 mounted outside the detection terminal of the probe can protect the fiber end from being damaged. Since the probe of the present invention is a reflection probe, the use of the protective window leads to a surface reflection, in which a portion of the light reflected from the interface may directly enter the receiving channels of the probe, thereby decreasing the dynamic detection range of the probe. In this case, it is highly recommended that an anti-reflection coating or a highly transmissible bandpass optical film is applied on the protective window 21, to eliminate or reduce the reflected light from the interface. Commonly the protective window 21 is made of sapphire or various optical glasses that is subjected to surface strengthening treatment to have a high density and a high transmittance. The optical probe can also comprise of an O-ring 22, when the optical probe is fitted with other mechanical members (not shown).

FIG. 4 shows the structure of another embodiment of the probe of the present invention. The probes in FIG. 4 and in FIG. 2 are different by the adapter shape, and the structure of the optical fiber probe in FIG. 4 is the same as that in FIG. 2. In the probe of FIG. 4, the adapter 33 is cylindrical in shape. Similar to the probe of FIG. 2, a fitting hole 331 for the optical fiber probe sits in the center of the adapter 33 and it has screw threads on its inner surface. The optical fiber probe 34 having transmitting and receiving optical fibers 341 can be screwed into the fitting hole 331 of the adapter 33 through threads on a fitting portion 342. It will be understood by a person skilled in the art that the adapter structures given in FIG. 2 and FIG. 4 are examples only, and other types of adapter structures can be employed according to different applications. The optical fiber probe having the transmitting and receiving optical fibers can be stably connected to the adapter through screw threads, and any other connection manners can be used to achieve the connection between the optical fiber probe and the adapter.

The optical probe of the present invention comprises of at least one transmitting optical fiber and at least two receiving optical fibers. Preferably, the transmitting optical fiber and the receiving optical fibers are integrated into an optical fiber probe. Optionally, the optical probe of the present invention can also comprise of any number of filling optical fibers. The filling optical fibers are usually used to allow the transmitting optical fibers and the receiving optical fibers to be firmly fixed into the optical fiber probe or to reduce the costs. The optical fiber probe according to the present invention may have more than one transmitting optical fiber and more than two receiving optical fibers, and the number and arrangement of the fibers can be selected and configured by a person skilled in the art according to specific detection requirements.

As shown in FIG. 5, in a preferred embodiment of the present invention, the optical probe comprises of nineteen silica optical fibers. Among these, eleven illumination optical fibers 52 in total are assembled in an illumination optical fiber branch; two reading (receiving) optical fibers 51 in total are respectively mounted in two detection optical fiber branches for providing two detection signals; six filling optical fibers 53 in total are not involved in measurement and only serve as processing aids to achieve stable installation of all the fibers. In FIG. 5, circles with vertical bars represent reading optical fibers 51, circles with left diagonals represent illumination optical fibers 52, and circles with right diagonals represent filling optical fibers 53. In the embodiment shown in FIG. 5, the transmitting optical fibers 52 are distributed around each of the receiving optical fibers 51, whereby each receiving optical fiber 51 can well receive reflected light.

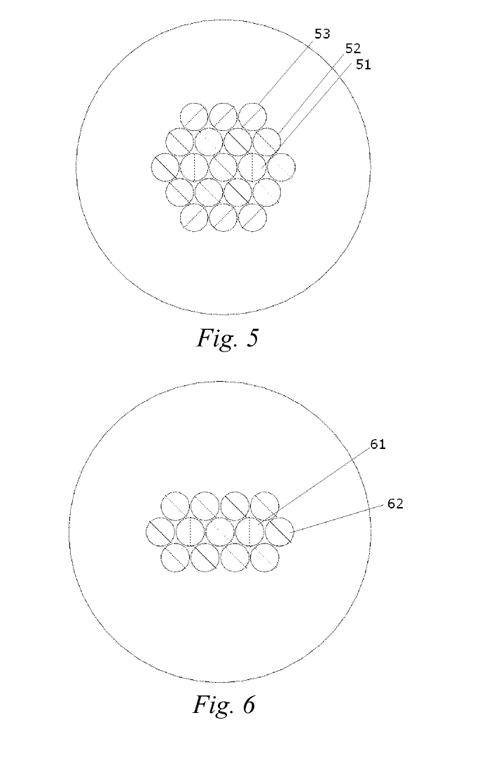

In another preferred embodiment of the present invention, the fiber arrangement of the optical probe is shown in FIG. 6. The embodiment of FIG. 6 is similar as that of FIG. 5, and the only difference is the absence of filling optical fibers. The arrangements of the transmitting optical fibers 62 and the receiving optical fibers 61 are the same as those in FIG. 5.

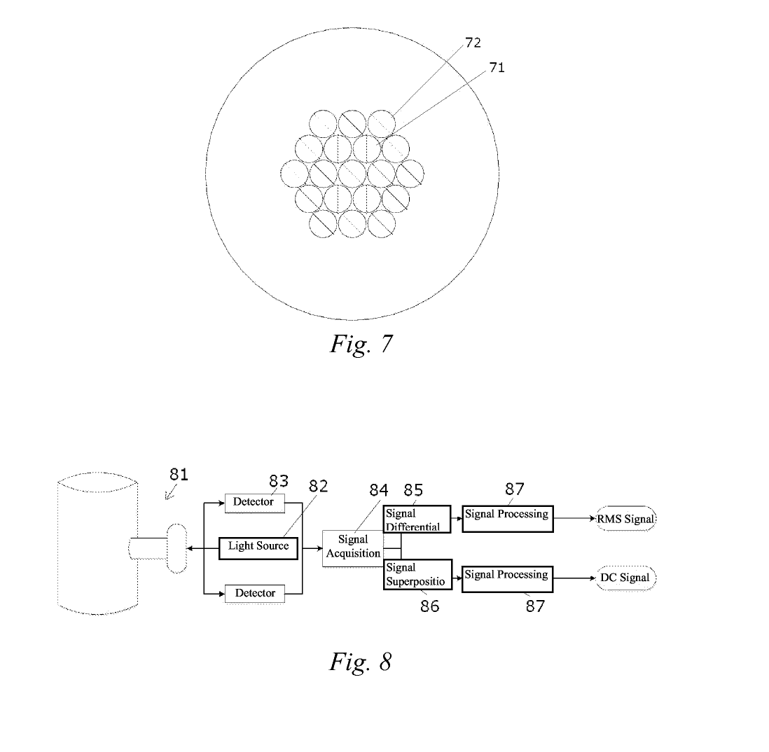

In other applications where a different detection channel number or stronger illumination light signal is needed, the overall optical fiber number, specific numbers of three types of optical fibers (transmitting optical fiber, receiving optical fiber, and filling optical fiber) and their arrangement may vary according to different applications. Where stronger illumination light signal and four detection channels are needed, the probe of the present invention can utilize detection terminal design as shown in FIG. 7. In the design of FIG. 7, fifteen illumination optical fibers 72, four detection optical fibers 71 and no filling optical fibers are used. Moreover, the fifteen illumination optical fibers 72 are located around 4 detection optical fibers 71.

The detection system of the present invention utilizes multiple (at least two) receiving optical fibers, which can effectively minimize errors resulting from electronic noise and abnormal optical signals.

The signal processing module of the detection system according to the present invention comprises of a photoelectric conversion portion for converting optical signals received by the receiving optical fibers into electrical signals. In an embodiment, the photoelectric conversion portion are the photodiodes connected to the receiving optical fibers. The photodiodes are driven by a circuit system, and optical signals received by the photodiodes are converted into an analog electrical signal via photoelectric conversion module. The signal processing module also comprises of an electrical signal processing portion for signal processing on the basis of the electrical signal from the photoelectric conversion portion and calculation and analysis of the nature of particles in the medium. In an embodiment, the signal processing portion may be achieved with the hardware and software modules of the circuit system.

In an embodiment, the original light signal received is converted into alternating signal (RMS signal) and direct signal (DC signal) after photoelectric conversion and subsequent calculation and processing, and accordingly, quantitative description of aggregation state of the suspended particles in a solution and measurement of turbidity signal value of the solution are done. The alternating current RMS signal represents particle state of the solution, and a stronger alternating current signal indicates a larger effective size of the suspended particles in the solution; while the direct current DC signal represents the turbidity value of the solution, and the stronger the DC signal, the larger the turbidity value of the solution.

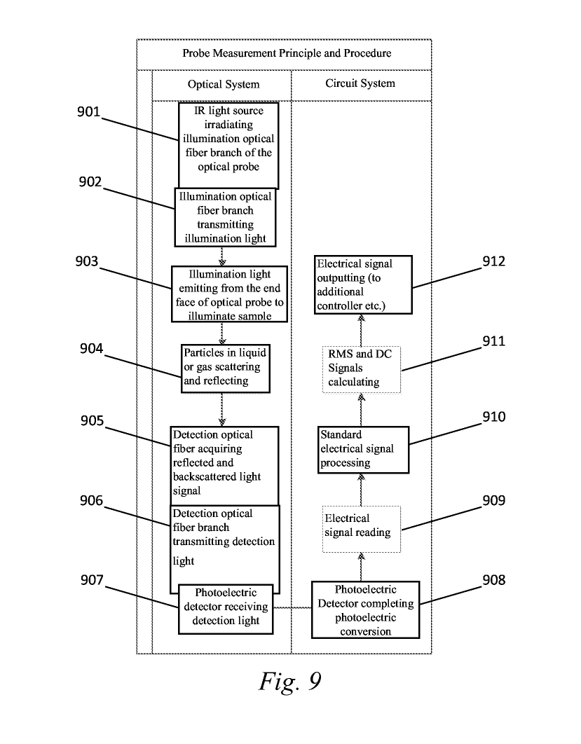

FIG. 8 schematically shows a block diagram of a signal processing module. A light source 82 and two detectors 83 are connected to the transmitting and receiving optical fibers of an optical probe 81 respectively. The detector 83 converts optical signals received into electrical signals and the electrical signals are received by a signal acquisition portion 84 of the circuit system. Two channels of electrical signals received are subjected to signal differential processing 85 and standard signal processing 87 to obtain the RMS signals. Meanwhile, the two channels of electrical signals received are subjected to signal superposition processing 86 and standard signal processing 87 to obtain the DC signal. FIG. 9 shows the flow chart of the detection system principle of the present invention. In FIG. 9, the Steps 901 to 907 are procedures of the optical system, and the Steps 908 to 912 are procedures of the circuit system.

In Step 901, an NIR light source illuminates the illumination optical fiber branch of the optical probe. In Step 902, the illumination optical fiber branch transmits illumination light. In Step 903, the illumination light is emitted from the end face of the optical probe to illuminate a sample (a medium to be detected). In Step 904, particles in the medium (which can be a liquid or gas) scatter and reflect the illumination light from the illumination optical fiber. In Step 905, the receiving optical fibers acquire light scattered and reflected by the particles. The light received is transmitted along the receiving optical fibers in Step 906 and arrives at the optical detectors in Step 907.

In Step 908, the optical detectors convert the light signal from the receiving optical fibers into the electrical signal, and the electrical signal is read by the signal processing circuit in Step 909. In Step 910, the electrical signal from the optical detectors is subjected to standardization processing, such as amplification, filtering and so on. The RMS signal and DC signal are calculated from the processed signal in Step 911. The RMS and DC signals obtained in Step 911 can be output to a display device or other control circuits in Step 912, whereby treatment required for the detected medium can be performed manually or automatically.

### Experimental Test

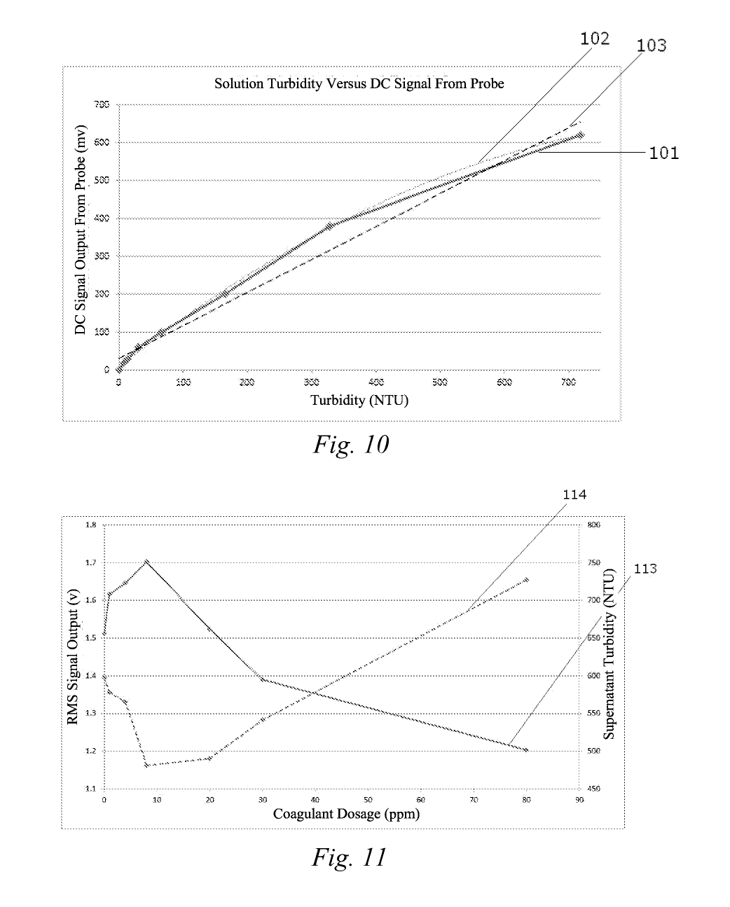

The DC signal output from the detection system of the present invention is used for characterizing solution turbidity, and a larger direct current signal indicates greater solution turbidity. For verification of the DC signal, kaolin solutions with different concentrations were used, and the turbidity value of each solution with specific concentration was calibrated by a commercial turbidimeter. A relationship between the actual turbidity values of various solutions and respective DC signal output of the probe was analyzed, and it is verified that the DC signal of the present invention can effectively and accurately characterize the actual turbidity values of the solutions. Table 1 shows the turbidity values of solutions with different concentrations and corresponding DC signal outputs of the probe, and FIG. 10 illustrates the relationship between turbidity value of the solution and DC signal output of the probe, as displayed in solid line 101. According to FIG. 10, there is a one-to-one numerical relationship in value between the turbidity value and direct current signal output. The linearity is generally good but not perfect because linear coefficients of section-wise linearity are different, such as in ranges below 100 NTU and above 100 NTU. In this case, section-wise linear calibration may be considered so that the probe can achieve a high accuracy throughout the whole detection range. Alternatively, quadratic polynomial fitting can be used, and thus calibration of the overall detection range can be done by a single calibration equation. In FIG. 10, curves obtained by quadratic polynomial fitting and linear fitting are shown. Quadratic polynomial fitting curve is displayed in short dash line 102 with polynomial fitting equation Y=−0.0007X²+1.3352X+10.083, where X represents turbidity value on x-axis, and Y represents DC signal output on y-axis. While linear fitting curve is displayed in long dash line 103 with the linear fitting equation Y=0.8662X+32.4, where X represents turbidity value on x-axis, and Y represents DC signal output on y-axis. It should be noted that the quadratic polynomial fitting equation and the linear fitting equation given here are examples only, and a different quadratic polynomial fitting equation or linear fitting equation can be used according to a desired curve fitting accuracy. A constant DC signal gain and light source output power are used in this experiment, and varying DC signal gains and light source output powers can be used according to specific turbidity range in the practical applications, which enables a 0-8000 NTU detection range of turbidity value when it is in combination with respective linear or quadratic polynomial fitting equations Experiment results prove that the DC signal of the probe of the present invention can effectively and accurately detect the turbidity value of a solution.

TABLE 1
Solution turbidity value and DC signal output from Probe

| Turbidity value (NTU) | DC signal output (mV) |
|---|---|
| 0 | 0 |
| 8.5 | 20 |
| 13 | 30 |
| 30 | 60 |
| 65 | 100 |
| 165 | 200 |
| 328 | 380 |
| 719 | 620 |

The RMS signal output from the probe of the present invention is used to characterize particle state in a solution. The larger the particle size, the larger the corresponding RMS signal. Different dosages of coagulants and flocculants will be added to a certain synthetic water sample or actual industrial wastewater so as to change the size and form of the suspended particles in the water sample being measured to different levels, thereby obtaining RMS signals of the probe under corresponding conditions. Since the particle state for most solutions directly affects the setting effect, a relationship between the turbidity values of supernatants at various dosages and corresponding RMS signals of the probe will be analyzed for verification and evaluation of the effectiveness and accuracy of the RMS signal of the probe of the present invention on characterization of the aggregation state of suspended particles in the solution.

An actual wastewater sample from a certain paper industry was tested as a sample, in which the aggregation state of the suspended particles in each solution at a different chemical dosage is measured using the probe of the present invention, so as to determine the type and dosage of the chemical agent which has a better settlement capability for the suspended particles in the solutions. In the experiment, different dosages of a coagulant (Nalco #8187) and a constant dosage of a flocculant (Nalco #7768) were added to the wastewater sample, respectively following standard operation protocol for manual jar testing, to ensure that the chemical agent can be adequately mixed and reacted with the water sample. The corresponding RMS signals of the probe were recorded in real time and averaged values were calculated for a period of time after particles reached stable state. After each measurement, the same procedure was strictly followed to detect the supernatant turbidity of the solution, which was measured by a commercial instrument. FIG. 11 shows the RMS signal and the supernatant turbidity as a function of coagulant dosage. Curve 113 indicates a relationship between the RMS signal and coagulant dosage, and curve 114 indicates a relationship between the supernatant turbidity and coagulant dosage. It can be known from the figure that the RMS signal of the probe of the present invention can accurately characterize the particle state of the suspended particles in the solution.

According to the detection system of the present invention, the optical probe can be directly inserted into a medium to be detected and light reflected from the medium can be used to detect the state of particles in the medium, thus achieving on-line detection. Since the detection system of the present invention adopts multiple (at least two) reading optical fibers, errors resulting from electronic noise and abnormal optical signals can be effectively excluded. In the detection system according to the present invention, by distributing the transmitting optical fibers around the receiving optical fibers, each of the receiving optical fibers can well receive the reflected light, thereby achieving a more effective and accurate measurement.

The on-line monitoring by the detection system of the present invention facilitates achieving the automatic feeding of a chemical agent during wastewater treatment, which has a significant effect on the increase of the return of investment. In many treatment processes for wastewater treatment, including primary and secondary treatments and sludge dehydration, successful automation of the jar test will lead to an efficient, rapid and low-cost treatment.

The probe can monitor a primary treatment procedure of secondary treatment and sludge dehydration in phase 1 and phase 2. A potential application is used in emulsion break-up procedure, such as in pulp and papermaking technology with a short operation period and in coal/water separation in mining, and the like.

The present invention also relates to a water treatment system and method, which uses the detection system of the present invention for detecting the particles in water, determines the dosage of chemical agents (for example, coagulants and flocculants) required to treat the water on the basis of detection results, and adds the determined dosage of the chemical agent to the water for water treatment. In an embodiment, the chemical agent is first added into the water for a plurality of times, with the dosage being different for each time, and the change of the particles' sizes are detected in the water after each addition of the chemical agent, and the dosage of the chemical agent required to treat the water is determined according to the relationship between the dosage of the chemical agent added therein and the change of the particles' sizes.

While some preferred embodiments of the present invention have been disclosed herein in detail, the present invention is not limited to the disclosed embodiments, which are examples only.

1. A detection system for detecting particle state of a medium, characterized by comprising:
an optical probe comprising at least one transmitting optical fiber for transmitting light to the medium, and at least two receiving optical fibers for receiving light reflected or backscattered from the medium, with at least the end of the optical probe being positioned in the medium when detection is carried out by the detection system; and
a signal processing module connected to the optical probe, for converting optical signals from the receiving optical fibers of the optical probe into electrical signals and determining particle state of the medium on the basis of the electrical signals.

2. The detection system according to claim 1, characterized in that said optical probe comprises a plurality of transmitting optical fibers, which are arranged in a manner to surround the receiving optical fibers.

3. (canceled)

4. The detection system according to claim 1, characterized in that said optical probe comprises fifteen transmitting optical fibers and two sets of receiving optical fibers, with each set thereof comprising two receiving optical fibers arranged in parallel, and ten transmitting optical fibers being arranged around each set of the receiving optical fibers.

5. The detection system according to claim 1, characterized in that said optical probe comprises a plurality of transmitting optical fibers and at least two receiving optical fibers, with said plurality of transmitting optical fibers being arranged into two rings linked to each other, and the receiving optical fibers being positioned in the centers of the rings, respectively.

6. (canceled)

7. The detection system according to claim 1, characterized in that said optical probe comprises a plurality of filling optical fibers and a protective window at the end thereof, said protective window is made of sapphire or optical glasses, and it has thereon a reflection reducing coating or an anti-reflection coating for a corresponding medium.

8. (canceled)

9. The detection system according to claim 1, characterized in that the optical probe comprises an optical fiber probe and an adaptor, with said transmitting optical fibers and said receiving optical fibers being fixed in the optical fiber probe, and said optical fiber probe and said adaptor being connected by screw threads.

10. The detection system according to claim 1, characterized in that said adaptor has a hole for fitting the optical fiber probe, with the hole having screw threads on its inner surface and said optical fiber probe having screw threads on its outer surface.

11. The detection system according to claim 10, characterized in that said optical fiber probe comprises a header for facilitating the screwing-in of the optical fiber probe into the hole for fitting the same, with the header comprising a plurality of anti-skid grooves.

12. The detection system according to claim 1, characterized in that said medium is a liquid.

13. The detection system according to claim 12, characterized in that said particle state includes the change of the particle size and the concentration of the particles.

14. The detection system according to claim 13, characterized in that said signal processing module acquires alternating current signals and direct current signals on the basis of the optical signals from the receiving optical fibers, determines the change of particle size in the medium on the basis of the alternating current signals, and determines the concentration of the medium on the basis of the direct current signals.

15. A water treatment system comprising a detection system as claimed in claim 1 for detecting the change of the particle size in water after having chemical agent or agents added therein, wherein said water treatment system determines the dosages of the chemical agents required for treating the water on the basis of the detection results from the detection system, and said determined dosages of the chemical agents are added to the water for treating the same.

16. The water treatment system according to claim 15, characterized by: said water treatment system adding the chemical agent or agents into the water for a plurality of times, with the dosage being different for each time; said detection system detecting the change of particle size after each addition of the chemical agents; and said water treatment system determining the dosages of the chemical agents required for treating the water according to the relationship between the dosages of the chemical agents added therein and the change of the particle size.

17. A method for detecting particle state in a medium, characterized by comprising:
transmitting light into the medium via at least one transmitting optical fiber in the medium;
receiving light reflected or backscattered from the medium via at least two receiving optical fibers in the medium; and
converting optical signals received by the receiving optical fibers into electrical signals, and determining particle state in the medium on the basis of the electrical signals.

18. The method according to claim 17, characterized in that the light is transmitted into the medium via a plurality of transmitting optical fibers, with the transmitting optical fibers being arranged in a manner to surround the receiving optical fibers.

19. (canceled)

20. The method according to claim 17, characterized in that said particle state includes the change of particle size and the concentration of the particles.

21. The method according to claim 17, characterized in that the optical signals received by the receiving optical fibers are converted into alternating current signals and direct current signals, and the change of particle size in the medium are determined on the basis of the alternating current signals and the concentration of the particles is determined on the basis of the direct current signals.

22. The method according to claim 17, characterized in that it further comprises:
connecting an optical fiber probe comprising said transmitting optical fibers and the receiving optical fibers to an adaptor by screw threads.

23. A water treatment method, comprising:
adding chemical agent or agents into water;
detecting the change of particle size in the water after having added therein the chemical agent or agents, according to the method as claimed in claim 17; and
determining the dosages of the chemical agents required for the water treatment according to the detected change of particle size in the water after having added therein the chemical agent or agents, and adding into the water said determined dosages of the chemical agents to treat the water.

24. The water treatment method according to claim 23, characterized by comprising:
adding the chemical agent or agents into the water for a plurality of times, with the dosage each time being different;
detecting the change of particle size in the water after having added the chemical agent or agents therein each time, and
determining the dosages of the chemical agents required for treating the water on the basis of the relationship between the dosages of the chemical agents and the change of particle size.
